(19) United States
(12) Patent Application Publication
(10) Pub. No.: US 2025/0019564 A1
(43) Pub. Date: Jan. 16, 2025

(54) SINGLE COMPONENT BODY FILLER COMPOSITION WITH USER CONTROLLED WORKING TIME

(71) Applicant: Illinois Tool Works Inc., Glenview, IL (US)

(72) Inventors: Reese Heckman, Glenview, IL (US); Emilie Yeoh, Glenview, IL (US); Duy Tran, Glenview, IL (US); Mehdi Habibpour, Glenview, IL (US); Carlton Seaboldt, Glenview, IL (US); Grant Shouldice, Glenview, IL (US)

(73) Assignee: Illinois Tool Works Inc., Glenview, IL (US)

(21) Appl. No.: 18/772,336

(22) Filed: Jul. 15, 2024

Related U.S. Application Data
(60) Provisional application No. 63/526,478, filed on Jul. 13, 2023.

(51) Int. Cl. C09D 163/10; C09D 7/61; C09D 175/14

(52) U.S. Cl. CPC C09D 163/10; C09D 7/61; C09D 175/14

(57) ABSTRACT

A single component curable composition is provided that includes a resin curable by free radicals. Free radicals are initiated by the inclusion of at least one photo-initiator, at least one thermal radical initiator, and at least one thermal cationic radical initiator, all present in a premixed state as the single component. The composition is able to cure to a depth beyond the penetration of photons into composition. Once cure is initiated with an ultraviolet or infrared light source, the light source need not illuminate the composition until cure is complete. The resulting composition has a user selected working time that is effectively infinite and the viscosity stable while working prior to initiating cure. A method for repairing a surface imperfection on a vehicle body is also provided along with a novel cured mass with a thickness of up to 7 mm.

### RELATED APPLICATIONS

This application is a non-provisional application that claims priority of U.S. Provisional Application Ser. No. 63/526,478 filed Jul. 13, 2023; the contents of which are hereby incorporated herein by reference.

### FIELD OF THE INVENTION

The present invention in general relates to unsaturated curable, single-component composition for vehicle body repair, and in particular to curable single-component composition used in repairing imperfections on surfaces of auto-body repair coatings with a user controlled working time.

### BACKGROUND OF THE INVENTION

Body filler compositions are used in the vehicle repair aftermarket industry to repair of deformities such as holes and dents in vehicle bodies. The filler composition cures following application to the deformity and upon reaching a level of hardness, the resulting coating overlying the defect is sanded and finished with suitable painting steps to affect the repair of the vehicle body.

Conventional bulk filler surface repair compositions for vehicles are often two part systems that cure under free radical conditions. Mixing errors and ambiguity as to when a repair has reached a sufficient hardness to allow for sanding are common reasons why these remedial repairs must be repeated. In traditional compositions, a separately packaged polymerization free radical initiator such as a peroxide must be added to the composition immediately before application to eventually cure the material. The amount of both composition and added initiator is often measured by visual approximation and this is prone to inaccuracy: if too much initiator is added, the composition cures too quickly, leading to reduced working time and overcuring; or if too little initiator is added, the filler may never cure. Furthermore, if the initiator is not properly mixed into the composition, uneven curing will occur. Each of these scenarios requires rework of the repair, leading to lost time that could be spent on other tasks.

Immediately upon adding the initiator to the composition, a polymerization reaction begins that slowly cures the material. This sets a fundamental limit on the amount of time available to apply the filler to the repair surface. After this “gel point” is reached, another 15-30 minutes is required to allow the filler to cure enough for sanding. This presents another inefficiency since this down time could be spent working on the repair if the filler was able to cure faster.

The limited working time for a composition once mixing and cure have begun can also lead to rushed efforts to affect a repair. While ultraviolet (UV) light cured systems have the advantage of a long working time until such time as the UV light initiates cure, such systems have been limited to comparatively shallow layers of curable resin owing to the limited depth of light induced cure penetration. In a use context, this has limited the usage of UV cured compositions to primers and pinhole corrective applications while bulk vehicle body filler compositions have had to rely on two-part systems that entail an initial mixing step and a limited working time that begins upon mixing. Attempts to sand these bulk filler repairs before properly cured can ruin the attempted repair requiring additional effort.

Thus, there exists a need for a single-component UV curable composition that retains the attribute of user selected working time that is also able to cure to a depth beyond that a depth of UV penetration. There further exists a need for a method of using such a composition that is UV curable and visually indicates when the body filler composition has achieved a hardness sufficient to sand, if needed.

### SUMMARY OF THE INVENTION

A single component curable composition is provided that includes a resin curable by free radicals. Free radicals are initiated by the inclusion of at least one photo-initiator, at least one thermal radical initiator, and at least one thermal cationic radical initiator, all present in a premixed state as the single component. The composition is able to cure to a depth beyond the penetration of photons into composition. Once cure is initiated with an ultraviolet or infrared light source, the light source need not illuminate the composition until cure is complete. The resulting composition has a user selected working time that is effectively infinite and the viscosity stable while working prior to initiating cure.

A method for repairing a surface imperfection on a vehicle body includes the application of an uncured layer of the composition to the vehicle body at a thickness. The uncured layer is then exposed to actinic radiation to induce cure to a depth of less than the thickness of the uncured layer. The composition is allowed to cure through the thickness to form a mass to fill the surface imperfection on the vehicle body through the actions of the thermal and cationic initiators in portions of the volume that are not exposed to the actinic radiation. The resulting mass with a thickness of from 2.5 to 6.5 millimeter (mm) is provided.

### DETAILED DESCRIPTION OF THE PREFERRED EMBODIMENTS

The present invention has utility as a single-component, ultraviolet (UV) light curable composition that has a user controlled working time and in contrast to the prior art is amenable to cure to thicknesses well beyond the penetration depth of the UV light thereby facilitating bulk volume repair without the constraints of finite working time. The present invention affords a user advantages in terms avoiding mixing common to two part systems and the ability to shape a vehicle body filler as desired before cure. As a result of the extended working time of the present invention, the filler can be applied in a way that fits the final dimensions of the repair such that after curing rework is minimized. This attribute is particularly helpful for those with limited experience in body repair as there is additional time to achieve correct shaping of a repair. Through resort to a one-component, UV curable filler composition mixing errors and user controlled working time that is practically unlimited are provided. An inventive filler composition achieves thicknesses more than 2.5 mm and even up to 6.5 mm though resort to a combination of cationic and thermal radical initiators that uses the exothermic heat of surface-initiated cure to induce secondary curing with the mass of the present invention that has not been exposed to UV cure. Still another advantage of the present invention is that less quanta of UV photons are required due to the secondary thermal curing. As a result, energy savings are achieved along with reduced user time to irradiate the curing composition relative to prior art systems. The present invention further limits the need for secondary cream hardeners that complicate repair as being a third component. In some inventive embodiments in which a color change agent is present, a user has a visual cue as to when the filler composition has achieved sufficient hardness to sand so as to eliminate yet another deficiency of prior art systems.

As used herein, “sandable” with reference to a cured inventive composition is defined as having limited clogging of sandpaper and able to form a featheredge.

As used herein, “photo-initiator” refers to a chemical that initiates free radical crosslinking/polymerizing reaction induction by UV light wavelengths.

As used herein, “thermal initiator” refers to a chemical that initiates radical crosslinking/polymerizing reaction induction by heat energy or infrared wavelengths. It is appreciated that some chemicals such as azobisisobutyronitrile (AIBN) can generate free radicals through both routes and can acts as both a photo-initiator and a thermal initiator. In those instances where a chemical has dual routes of induction, another initiator chemical is present and may be one of the aforementioned types or a cationic initiator.

As used herein, a “microspheroid” is defined to include a hollow microsphere or a solid bead having an aspect ratio of between two normal maximal linear dimensions of between 1 and 1.6. Typically, a spheroid particle is formed of glass or a thermoplastic material. In some inventive embodiments, the microspheroid is within 10 linear dimension percent of spherical and formed of glass. A microspheroid typically has a longest linear dimension of between 20 and 100 microns to improve sandability and reduce density.

As used herein, “acrylate” is defined to include both acrylates and methacrylates.

Numerical ranges cited herein are intended to recite not only the end values of such ranges but the individual values encompassed within the range and varying in single units of the last significant FIGURE. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

Photo polymerization reactions are induced in the present invention using a variety of light sources such as low energy consuming and environmentally friendly ultraviolet light emitting diode (UV-LED), older mercury or xenon arc lights, a heat lamp, or simply magnified sunlight. Absent UV exposure, an inventive filler composition has a working time that is determined by the user and is effectively infinite yet cures rapidly upon UV exposure or in the alternative also with intense heat or IR light exposure thereby offering a user a controlled working time and a rapid cure thereafter. Working time is selected by a user typically are on the order of several hours, for example 2 to 10 hours, but is appreciated to a user selectable variable; in stark contrast to the typical prior art working time of 3 to 5 minutes. As a result, the applied material can be corrected or reworked without the conventional problem of viscosity build as two-part composition cures. Also, the inclusion of a thermal initiator, a cationic thermal initiator, or a combination thereof reduces the amount of radiation commonly used in a conventional UV curing composition to induce full cure to the depth of UV light penetration into the uncured mass.

An inventive composition includes a resin inclusive of acrylate, epoxy, or polyurethane ethylenic unsaturations.

A curable acrylate resin operative herein is derived from one or more ethylenically unsaturated monomers which are copolymerizable with the latent-crosslinking co-monomer. Examples of suitable ethylenically unsaturated monomers include alpha olefins such as ethylene, propylene, butylene, isobutylene; diene monomers such as butadiene, chloroprene, isoprene; and aromatic and aliphatic vinyl monomers including vinyl halides such as vinyl chloride and vinylidene chloride; vinyl esters of alkanoic acids having from one to eighteen carbon atoms, such as vinyl formate, vinyl acetate, vinyl propionate, vinyl butyrate, vinyl isobutyrate, vinyl valerate, vinyl 2-ethylhexanoate, vinyl isoctanoate, vinyl monoate, vinyl decanoate, and vinyl pivalate; vinyl esters of saturated carboxylic acids; vinyl aromatic compounds such as styrene, alpha methylstyrene, vinyl toluene, 2-bromostyrene, p-chlorostyrene; and other vinyl monomers such as acrylonitrile, methacrylonitrile, N-vinylpyrrolidone, maleate, fumarate, and itaconate esters of C₁-C₈ alcohols. A specific group of acrlyate resins operative herein are based on acrylic monomers and in particular C₂-C₁₈ alkyl acrylates and C₂-C₁₈ alkyl methacrylates. Examples of the C₂-C₁₈ alkyl groups of the esters of acrylic and methacrylic acids which are useful in forming the copolymers of the invention include methyl, ethyl, n-butyl, i-butyl, sec-butyl, t-butyl, the various isomeric pentyl, hexyl, heptyl, and octyl (especially 2-ethylhexyl), isoformyl, lauryl, cetyl, stearyl, and like groups. Ethylenically unsaturated monomers for the present invention illustratively include aliphatic and aromatic vinyl monomers. Primary monomers operative herein illustratively include are unsaturated monomers of alkyl acrylates, alkyl methacrylates, acrylonitrile, acrylamide, styrene and vinyl acetate.

A curable resin reactive present in combination with a crosslinking agent is typically also present from 10 to 95 total weight percent with an approximately stoichiometric amount of a crosslinking agent based on reactive moieties. For example, a difunctional resin and a difunctional crosslinking agent being present in a 1:1 molecular ratio. “Approximate” in the context of stoichiometry is intended to be ±10%. Reactive resins used in the present invention have a weight average molecular average weight ranging from 500 to 600,000, as determined by gas permeation chromatography (GPC).

A crosslinking agent that is multifunctional is also present in an inventive body filler composition. As used herein, multifunctional is defined as a compound that has a polymerizable functionality of at least 2. Difunctional crosslinking agents are particularly well suited for use in the present invention. Crosslinking agents operative in the present invention illustratively include diallyl fumarate, diallyl diglycol carbonate, allyl methacrylate, isobornyl acrylate, diallyl phthalate, diallyl suberate, diallyl tetrabromophthalate, diethylene glycol diacrylate, diethylene glycol dimethacrylate, diethylene glycol divinyl-ether, N,N′-dimethacryloylpiperazine, 2,2-dimethylpropanediol dimethacrylate, dipentaerythritol pentaacrylate, dipropylene glycol dimethacrylate, di-trimethylolpropane tetraacrylate, divinyl glycol, divinyl sebacate, glycerol trimethacrylate, 1,5-hexadiene, 1,6-hexanediol diacrylate, 1,6-hexanediol dimethacrylate, N,N′-methylenebismethacrylamide, 1,9-nonanediol dimethacrylate, pentaerythritol tetraacylate, pentaerythrtol triacrylate, pentaerythritol triallyl ether, 1,5-pentanediol dimethacrylate, poly(propylene glycol) dimethacrylate, tetraethylene glycol dimethacrylate, triethylene glycol diacrylate, triethylene glycol dimethacrylate, dipropylene glycol diacrylate, triethylene glycol divinyl ether, 1,1,1-trimethylolethane trimethacrylate, 1,1,1-trimethylolpropane diallyl ether, 1,1,1-trimethylolpropane triacrylate, 1,1,1-trimethylolpropane trimethacrylate, tripropylene glycol diacrylate, 1,2,4-trivinylcyclohexane, divinyl benzene, bis(2-methacryloxyethyl)phosphate, 2,2-bis(4-methacryloxyphenyl)propane, 1,3-butanediol diacrylate, 1,4-butanediol diacrylate, 1,3-butanediol dimethacrylate, 1,4-butanediol dimethacrylate, 1,4-butanediol divinyl ether, 1,4-cyclohexanediol dimethacrylate, bis[4-(vinyloxy)butyl]isophthalate, bis[4-(vinyloxymethyl)cyclohexylmethyl]glutarate, bis[-(vinyloxy)butyl]succinate, bis((4-((-vinyloxy)methyl)cyclohexyl)methyl)isophthalate, bis(4-(vinyloxy)butyl)terephthalate, bis[[(4-[vinyloxy)methyl)cyclohexyl]methyl]terephthalate, bis[4-vinyloxy)butyl]adipate, bis[4-(vinyloxy)butyl](methylenedi-1,4-phenylene)biscarbamate, bis-[4-(vinyloxy)butyl](4-methyl-1,3-phenylene)biscarbamate, bis[4-(vinyloxy)butyl]1,6-hexanediylbiscarbamate, tris[4-(vinyloxy)butyl]trimellitate or combinations thereof. It is appreciated that a minority amount of trifunctional or higher functional crosslinking agent present modifies the cured coating properties. Typical loadings of crosslinking agent in an inventive filler composition are from 0.1 to 30% total weight percent of a fully formulated filler composition.

In order to achieve enhanced rates of actinic cure, a photoinitiator is present from 0.1 to 5 total weight percent. Bisacylphosphine oxides (BAPO) are exemplary of a photoinitiator operative in the present invention. Specific bisacylphosphine oxides operative herein illustratively in phenyl bis(2, 4, 6-trimethylbenzoyl)-phosphine oxide, diphenyl(2,4,6-trimethylbenzoyl)phosphine oxide, bis-(2,6-dichlorobenzoyl)phenylphosphine oxide, bis-(2,6-dichlorobenzoyl)-2,5-dimethylphenylphosphine oxide, bis-(2,6-dichiorobenzoyi)-4-ethoxyphenylphosphine oxide, bis-(2,6-dichlorobenzoyl)-4-biphenylylphosphine oxide, bis-(2,6-dichlorobenzoyl)-4-propylphenylphosphine oxide, bis-(2,6-dichlorobenzoyl)-2-naphthylphosphine oxide, bis-(2,6-dichlorobenzoyl)-1-napthylphosphine oxide, bis-(2,6-dichlorobenzoyl)-4-chlorophenylphosphine oxide, bis-(2,6-dichlorobenzoyl)-2,4-dimethoxyphenylphosphine oxide, bis-(2,6-dichlorobenzoyl)decylphosphine oxide, bis-(2,6-dichlorobenzoyl)-4-octylphenylphosphine oxide, bis-(2,6-dimethoxybenzoyl)-2,5-dimethylphenylphosphine oxide bis-(2,6-dimethoxybenzoyl)phenylphosphine oxide, bis-(2,4,6-trimethylbenzoyl)-2,5-dimethylphenylphosphine oxide, bis-(2,6-dichloro-3,4,5-trimethoxybenzoyl)-2,5-dimethylphenylphosphine oxide, bis-(2,6-dichloro-3,4,5-trimethoxybenzoyl)-4-ethoxyphenylphosphine oxide, bis-(2-methy-1-naphthoyl)-2,5-dimethylphenylphosphine oxide, bis-(2-methyl-1-naphthoyl)phenylphosphine oxide, bis-(2-methyl-1-naphthoyl)-4-biphenylphosphine oxide, bis-(2-methyl-1-naphthoyl)-4-ethoxyphenylphosphine oxide, bis-(2-methyl-1-naphthoyl)-2-naphthylphosphine oxide, bis-(2-methyl-1-naphthoyl)-4-propylphenylphosphine oxide, bis-2-methyl-1naphthoyl)-2,5-dimethylphosphine oxide, bis-(2-methoxy-1-naphthoyl)-4-ethoxyphenylphosphine oxide, bis-(2-methoxy-1-naphthoyl)-4-biphenylylphosphine oxide, bis-(2-methoxy-1-naphthoyl)-2-naphthylphosphine oxide, bis-(2-chloro-1-naphthoyl)-2,5-dimethylphenylphosphine oxide, and combinations thereof. Still other photoinitiators operative herein include mono-aryl ketones, and trimethylbenzoyldiphenyl phosphinates, with specific examples thereof illustratively including 1-hydroxycyclohexyl phenyl ketone, 2-hydroxy-2-methyl-1-phenyl-propan-1-one, ethyl-2,4,6-trimethylbenzoylphenyl phosphinate In some inventive embodiments, liquid blends of photoinitiators are provided by dissolving solid bisacylphosphine oxide photoinitiator in another liquid photoinitiator or a photoinitiator blend which is of liquid form.

In order to achieve thermal cure, a thermal radical initiator is present from 0.1 to 5 total weight percent. A thermal radical initiator operative herein include ketone peroxides, peroxyketals, dialkyl peroxides, hydroperoxides, peroxyesters, diacyl peroxides, peroxydicarbonate, polyols, azo compounds, and combinations thereof. Specific examples of thermal radical initiators operative herein include azobisisobutyronitrile (AIBN); 2,2′-azobis(2,4-dimethylpentanenitrile); pinacol, those detailed in U.S. Pat. No. 4,336,366; and combinations thereof. The mechanisms of thermal cure are known to the art as detailed in B. Dietrich, Intl. J. of Poly. Sci. 2009 (1687-9422), Article ID 893234, 10 pages.

In order to achieve thermal cure, a thermal cationic initiator is present from 0.1 to 5 total weight percent. A thermal cationic initiator operative herein include benzylpyridinium or ammonium salts of a non-nucleophilic anion such as, for example, hexafluorophosphate, tetrafluoroborate, hexafluoroantimonate, tris(trifluoromethylsulfonyl) methide, or hexafluoroarsenate anion; benzenesulfonate anions of benzylphyridinium or benzylammonium salts; those detailed in U.S. Pat. No. 5,070,161; benzylanilinium and p-substituted benzylanilinium salts of non-nucleophilic anions, such as SbF₆⁻ that include for example, bis(4-dodecylphenyl)iodonium hexafluoroantimonate; and iron-based salts such as those described in U.S. Pat. No. 6,906,156.

Table 1 lists the major components of an embodiment of the inventive curable composition.

TABLE 1
Composition of a UV and thermal curable
vehicle body repair composition,

| | Typical Total | Preferred Total |
|---|---|---|
| Ingredient | Weight Percent | Weight Percent |
| Self-curable resin/resin + | 10-95 | |
| crosslinking agent | | |
| Photoinitiator | 0.1-5 | 0.1-1.8 |
| Thermal radical initiator | 0.1-5 | 0.8-2.8 |
| Thermal cationic initiator | 0.1-5 | 0.8-4.8 |
| Anti-oxidant | 0-6 | 0.1-1.0 |
| Solvent | 5-30 | 8-19 |
| Additives | 0-12 | Each: 0.1-12 |
| Filler (e.g. pigment, talc, | Remainder | Remainder (up to 45 |
| microspheres) | | volume percent) |

For purposes of calculating monomer percent, reactive diluents are omitted. Base epoxy/acrylate composites compositions operative herein are detailed in Table 1.

In some inventive embodiments, an anti-oxidant is present in an inventive composition and without intending to be bound to a particular theory is believed to function as a cure inhibitor to mitigate premature cure. An antioxidant operative herein illustratively includes butylated hydroxyanisole, 2,6-di-ter-butyl cresol, 2,2′-methylene bis(6-t-butyl-4-methyl phenol), 2,2′-thio bis(6-t-butyl-4-methyl phenol), tert-butyl hydroquinone, di-tert-butyl hydroquinone, di-tert-amyl hydroquinone, methyl hydroquinone, p-methoxy phenol, tetrakis[methylene-3-(3′,5′-di-tert-butyl-4′-hydroxyphenyl)propionate]methane, N-(2-aminoethyl)-3-[3,5-bis(tert-butyl)-4-hydroxyphenyl]propanamide, 5,7-di-tert-butyl-3-(3,4,-dimethylphenyl)-3H-benzofuran-2-one, dilauryl thiodipropionate, dimyristyl thiodipropionate, tris(nonylphenyl) phosphite, and combinations thereof. Typical loadings of an anti-oxidant in an inventive filler composition are from 0 to 6 total weight percent of a fully formulated body filler composition.

To further control viscosity and while not intending to be bound by theory, it is believed that solvents can be effective as a dispersive vehicle for the fillers and resins in an inventive body filler composition prior to curing, yet without inducing pinholes upon cure. During the application of the filler composition, solvents aid in achieving an appropriate viscosity of the filler composition. However, after the coating has been cured, it can be expected that there is less than 0.1% of the solvent to no detectable residual solvent. Solvents operative herein illustratively include hydrocarbons, alcohols, polyols, ketones, ethers, and pyrrolidinones, subject to the proviso that the solvent has a molecular weight of less than 300 Daltons. Examples of hydrocarbons operative herein illustratively include Stoddard solvent, toluene, xylene, naphtha, petroleum distillates, ethyl benzene, trimethyl benzenes, and fractions of hydrocarbon mixtures obtained from petroleum refineries. Alcohols operative herein illustratively include ethanol, n-propanol, iso-propanol, n-butanol, iso-butanol, benzyl alcohol, 2-(n-propoxy)ethanol, 2-(n-butoxy)ethanol, 3-(n-propoxy)ethanol, and 2-phenoxyethanol. Ketones operative herein illustratively include acetone, methyl ethyl ketone, methyl n-propyl ketone, methyl n-butyl ketone, methyl amyl ketone, and methyl isoamyl ketone. Esters operative herein illustratively include ethyl propanoate, ethyl butanoate, ethyl glycolate, propyl glycolate, butyl glycolate, and isoamyl glycolate, methyl acetate, ethyl acetate, n-butyl acetate, isoamyl acetate, and t-butyl acetate. Glycols operative herein illustratively include ethylene glycol and polypropylene glycol. Glycol ethers operative herein illustratively include propylene glycol monomethyl ether and ethylene glycol monobutyl ether. Pyrrolidinones operative herein illustratively include 1-methyl-2-pyrrolidinone and 1-ethylpyrrolidin-2-one. Mixtures of any two or more of these solvents may also be utilized. Mixtures of miscible combinations of any of the aforementioned are also appreciated to be operative herein. Solvent is typically present in an inventive filler composition from 5 to 30 weight percent.

Several additives are readily included in an inventive filler composition that illustratively include corrosion inhibitors, flow control additives, a surface hardener, a color changing dye indicative of extent of cure, pigments and dyes and combinations thereof. A color changing dye indicative of the extent of cure is detailed in US2020/0239710A1. An exemplary surface hardener is solution made of styrene monomer and paraffin waxes and eliminates surface tackiness as the wax rises to the surface as the styrene is released in the air. This non-tacky surface is amenable to sanding and/or painting. Generally, each of the aforementioned additives is independently present from 0 to 12 total weight percent.

Filler particulates or fibers operative in the present invention illustratively include talc, alumina trihydrate, calcium sulfate, calcium carbonate, magnesium sulfate, magnesium carbonate, barium sulfate, microspheroids and the like. A filler is present as the remainder total weight percent of a complete body filler composition for application to a substrate, with a typical upper limit being 60 volume percent of the uncured filler composition. It is appreciated that a pigment and filler can have the same function and in those instances where both are present in a filler composition, the amounts of both are cumulative.

It is appreciated that the inventive composition is readily be reapplied as many times as necessary to build a desired thickness and is typically formed as a putty amenable to spreading with a blade or trowel. The attributes of an inventive composition as to having a user controlled working time, single component, and being curable to a depth beyond UV penetration therein allows to one use the inventive composition in previously not possible with conventional vehicle repair filler materials. Upon cure, a repair with enhanced strength results through the interaction of the cured material being continuous through the holes or slits.

The UV radiation necessary for curing can be provided from several sources, including mercury arc lamps, xenon arc lamps, and UV-light emitting diodes (UV-LED). Because of the lower consumption of energy, and reduced heating of the substrate, UV-LED curing is often a preferred actinic radiation source for curing relative to a mercury arc lamp. The UV-LED bulbs do not generate ozone, in contrast to the typical UV-bulbs, require less energy, and exhibit a longer lifetime. It is appreciated that due to multiple mechanisms of cure associated with an inventive composition, cure is also initiated with a thermal source such as an infrared lamp or a heat gun. Furthermore, once free radicals are generated in an inventive composition, regardless of the source applied, cure continues throughout the dimensions of the composition and well beyond the depth UV light penetration therein.

The present invention is further detailed with respect to the following non limiting examples. These examples are not intended to limit the scope of the invention but rather highlight properties of specific inventive embodiments and the superior performance thereof relative to comparative examples.

### EXAMPLES

### Example 1

An inventive composition is formed by adding to 36 grams an acrylated epoxy resin (EPON 828), successively 15 grams of trimethylpropanetriacrylate, 1 gram of phenylbis(2,4,6-trimethylbenzoyl)phosphine oxide, 2 grams of benzopinacol, 1.5 grams of bis(4-dodecylphenyl)iodonium hexafluoroantimonate, 1.5 grams of mono[(C₁₂₋₁₄-alkyloxy)methyl]oxirane, 0.3 grams of a styrene/wax surface hardener, and color changing Red Dye FR-1 per US2020/0239710A1 present at 0.1 total weight percent. After mixing for 5 minutes, a combination of talc and microspheroid fillers are added to bring the total weight to 100 grams. The composition is then mixed under a vacuum of 500 mm Hg for 5 minutes to remove any air bubbles.

### Example 2

A defect in an automotive vehicle exterior to a maximal thickness of 7 mm is prepared by conventional techniques. Using a paint stick, the composition is gently mixed to ensure there is no separation. A necessary amount of the composition of Example 1 is transferred for the repair to a mixing board. Using a spreader, the surface of the target repair area is wet with the composition. The composition is applied in layers until the desired thickness is attained. When the composition has been properly shaped and is ready to cure a UV gun output of actinic radiation illuminates the composition surface on the vehicle body for 5-15 minutes at a distance of approximately 10 cm. The composition fully cured in a time of 5 to 15 minutes to a sandable hardness. A color change occurs within 5 minutes of the sandable hardness. Optionally, putties or pinhole eliminators are then applied and lightly sand until smooth. A paint primer is then applied. Paint/topcoat is applied over the primer to complete the repair.

### Example 3

The process of Example 2 is repeated with an acrylated urethane resin replacing the acrylated epoxy resin of Example 1. A similar cure profile results.

### Example 4

The process of Example 2 is repeated with bis-(4-t-butylphenyl)-iodonium hexafluorophosphate replacing the bis(4-dodecylphenyl)iodonium hexafluoroantimonate of Example 1. A similar cure profile results.

### Example 5

The process of Example 2 is repeated with t-butyl-peroxybenzoate replacing the pinacol of Example 1. A similar cure profile results.

### Example 6

The process of Example 2 is repeated with benzoyl peroxide replacing the pinacol of Example 1. A similar cure profile results.

### Example 7

The process of Example 2 is repeated with a heat gun instead of the UV-LED. The surface of the composition heated to approximately 125° C. for a period of from 30 seconds to 2 minutes. A similar cure profile results.

### Example 8

The process of Example 2 is repeated with an infrared lamp having a working temperature can reach 80-100° C. and containing a quartz halogen 2000 W shortwave infrared lamp instead of the UV-LED. The surface of the composition heated to approximately 125° C. for a period of 3-5 minutes. A similar cure profile results.

These examples demonstrate the processes to be claimed in this patent filing. It should be remarked that other additions and modifications as known in the art are also expected to be covered.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A single component curable composition comprising:
a resin curable by free radicals;
at least one photo-initiator;
at least one thermal radical initiator; and
at least one thermal cationic radical initiator, all present in a premixed state as the single component.

2. The composition of claim 1 further comprising a multifunctional crosslinking agent.

3. The composition of claim 1 further comprising a particulate filler.

4. The composition of claim 1 further comprising an aliphatic urethane acrylate resin.

5. The composition of claim 1 wherein said multifunctional crosslinking agent resin is a diacrylate.

6. The composition of claim 1 wherein the at least one thermal radical initiator comprises a ketone peroxide, a peroxyketal, a dialkyl peroxids, a hydroperoxide, a peroxyesters, a diacyl peroxide, a peroxydicarbonate, a polyol, an azo compound, or a combination thereof.

7. The composition of claim 6 wherein the thermal cationic radical initiator is a benzylpyridinium or ammonium salt of a non-nucleophilic anion, or a combination thereof.

8. The composition of claim 7 wherein the non-nucleophilic anion is hexafluorophosphate, tetrafluoroborate, hexafluoroantimonate, tris(trifluoromethylsulfonyl) methide, hexafluoroarsenate, or a combination thereof.

9. The filler composition of claim 3 wherein said particulate filler comprises at least one of talc, alumina trihydrate, calcium sulfate, calcium carbonate, magnesium sulfate, magnesium carbonate, barium sulfate, or microspheroids.

10. The filler composition of claim 1 further comprising at least one additive of corrosion inhibitors, flow control additives, a color changing dye indicative of extent of cure, pigments and dyes and combinations of any of the aforementioned.

11. The filler composition of claim 10 wherein each of the at least one additives is independently present up to 12 total weight percent.

12. A method for repairing a surface imperfection on a vehicle body comprising: applying an uncured layer of a composition of claim 1 to the vehicle body at a thickness; and exposing the uncured layer to actinic radiation to induce cure to a depth of less than the thickness of the uncured layer and allowing the composition to cure through the thickness to form a mass to fill the surface imperfection on the vehicle body.

13. The method of claim 12 further comprising applying an overlayer of a primer or paint on the coating.

14. The method of claim 12 wherein a thermal radical initiator and cationic initiator beneath the depth induces cure through to the thickness without being directly contacted by the actinic radiation.

15. The method of claim 12 wherein the exposing is less than an amount of radiation to induce full cure to the depth.

16. The method of claim 12 wherein a time between the applying and the exposing is selected by the user is several hours.

17. The method of claim 12 further comprising a color change occurring within 10 minutes of the coating being hard enough to sand.

18. The method of claim 12 wherein the actinic radiation is from an ultraviolet LED, a heat gun, or an infrared lamp and for a duration of 30 seconds to 15 minutes.

19. A mass formed by the method of claim 12 with a thickness of up to 7 mm.
